(19) United States
(12) Patent Application Publication
(10) Pub. No.: US 2005/0070258 A1
(43) Pub. Date: Mar. 31, 2005

(54) Personal communication devices with theme park system

(76) Inventor: Bart D. Stanco, Fairfield, CT (US)

Correspondence Address: BACHMAN & LAPOINTE, P.C., 900 CHAPEL STREET, SUITE 1201, NEW HAVEN, CT, 06510, US

(21) Appl. No.: 10/916,791

(22) Filed: Aug. 11, 2004

Related U.S. Application Data
(60) Provisional application No. 60/494,139, filed on Aug. 11, 2003.

(51) Int. Cl. H04Q 7/20

(52) U.S. Cl. 455/414.1; 455/414.2

(57) ABSTRACT

A system for enhancing a theme park visit, including a communication device and a source of theme park related information wherein the communication device is communicated with the source whereby the information can be accessed and obtained by a user of the communication device.

### BACKGROUND OF THE INVENTION

This invention relates to systems, methods and processes for allowing members of a group, for example, family members, friends, and other groups of individuals, to instantly speak with and locate one another. The invention further provides for communication between an individual and a service provider such as a theme park whereby the service can be enhanced through the use of the system.

Global Positioning Satellite (GPS) technology and services are available today for a variety of applications. Relevant to this invention are the devices that provide location services with the use of GPS. Applied Digital Solutions offers “Digital Angel”, a cigarette pack size unit that clips to the belt and provides GPS location services. Another company, Whereby Wireless, is marketing a GPS child locator in the form of a wrist watch. The watch includes a 911 call button. Parents can pinpoint location of a child via a web site or a call to a special hot line.

The object of the invention is to enhance these technologies and provide a versatile system for communicating individuals for enhanced safety, peace of mind, convenience and the like.

A further object of the invention is to provide a system and method whereby enjoyment of a service facility such as a theme park can be enhanced.

Other objects and advantages will appear hereinbelow.

### SUMMARY OF THE INVENTION

In accordance with the present invention, a method and processes are provided which combine GPS and Direct Talk (DT) or walkie-talkie-like communication providing both location and voice services, in a secure and convenient manner.

Combination of cellular triangulation and GPS for location services enables several new capabilities. With cell triangulation algorithms, location services can be provided within 100 meters. Cell triangulation provides “indoor” coverage while GPS does not, so with cell triangulation as the default mode, less battery usage is required and therefore smaller devices are possible to integrate location services and direct talk features. GPS provides a more exact location for “outdoor” locations and can be activated “on demand” for more optimized use of power at the same time, thereby enabling providing coverage indoors via cellular triangulation and outdoors via cellular triangulation or GPS depending upon accuracy needs and available batter power.

Authentication is a critical feature of the present invention, and users of the service must be authenticated for safety reasons. Strong authentication schemes are devised to identify the users. Voice, other biometrics (e.g., finger print), smart cards and the like are implemented as part of this invention. Un-authenticated voice calls and instructions are incorporated into the system, which is preferably adapted to drop unauthorized communications before reaching the receiver and/or take other appropriate action.

This invention allows the optimized use of many devices for different purposes. Devices integrate direct talk, GPS, and cell location services. These devices can be simple and lightweight. For example, a wristwatch or a pendant can be provided having navigating (thumb) button, yes/no buttons, and emergency button. To download contacts, other information, and synchronization, these devices can be equipped with a cradle with connection to processors such as PCs and PDAs, cell phones and other smart devices.

Many applications are possible for integration with the above services, including:

sending street address directly to the phone display “on demand” or as per configured schemes;

access to emergency and medical databases by 911 services and health care providers; and

mapping of hot zones such that, for example, as a user moves outside of a hot zone, alert(s) are sent to the other device(s).

Combining the devices and applications are a set of processes and procedures that allow users to take full advantage of the services conveniently. For example, call centers are set up to connect users (with proper authentication) if other forms of direct connections fail. Call centers can also feed medical and other information to healthcare providers.

A unique business process is provided by which individuals, for example family members and/or friends, stay connected instantly and securely anytime anywhere with many value added services.

A further aspect of the invention involves utilizing the system of the present invention to communicate individuals with management and other aspects of a service facility such as a theme park so as to enhance that individual's experience in that facility, as well as thereafter.

### BRIEF DESCRIPTION OF THE DRAWINGS

A detailed description of preferred embodiments of the present invention follows, with reference to the attached drawings wherein:

FIG. 1 illustrates the operator interface portion of a device in accordance with the present invention;

FIG. 2 illustrates a web site page utilizing a function of the system of the present invention;

FIG. 3 illustrates a fire walled operator network in accordance with a system of the present invention; and

FIG. 4 further illustrates a fire walled operator network in accordance with the present invention.

### DETAILED DESCRIPTION

The invention relates to a system including methods and processes for individuals such as family members, friends and the like to instantly speak with and locate one another in a secure and highly functional manner.

According to the invention, a communication device is provided, as well as a system incorporating same, whereby authenticated users have access to communication and location services. The device is simple to use and can be tailored to a wide variety of different consumers or other users.

Integral to the system are portable devices which can be incorporated into pendants, wristwatch devices and the like, and an operator network, each of which is further described below. While the description in connection with FIGS. 1-4 below is given in connection with communication between individuals, the system of the invention is likewise adapted to use in enjoyment of a services facility such as a theme park.

FIG. 1 shows the interface portion of a device 10 in accordance with the invention which, in this case, is a device which could readily be adapted for wearing as a pendant, or on a band as a wristwatch, or in other ways.

Device 10 includes controls which are desirably simple typically including a display 12, and a plurality of buttons generally indicated at 14 including navigating buttons, a select button, on-off buttons and the like. In addition, it is preferred that device 10 include a button for the “direct talk” or walkie-talkie-like feature of the device, and a further button which is intended for use in an emergency and which initiates an emergency protocol.

Device 10 is preferably adapted to connect with or fit on a cradle, not shown in FIG. 1, for downloading applications, DT numbers and other data with synchronization capability. In this manner, or in other ways, device 10 can be provided with programming as desired.

The embodiment illustrated in FIG. 1 is most preferably adapted for use as a pendant, in a wristwatch version of this device, similar buttons are adapted and incorporated along with digital watch capability, and a suitable battery can be an integral part of the wristband.

Device 10 is advantageously adapted to communicate with location sensing or tracking services such as GPS, cell triangulation, or both, so that location of device 10 can be conveyed to an authenticated user of the network.

The electronics and type of programming for providing a device 10 in accordance with the present invention are well within the level of skill of a person of ordinary skill in the art. Nevertheless, these features will be further discussed below.

Although FIG. 1 shows device 10 as a pendant, it should be noted that device 10 could also be provided in the form of a locket, for example with photos and pin on structures, or as a beeper, or as a pet track collar, or as a device incorporated into a camera, as several example.

The system components and functionality can also be repackaged into other product specifically for different situations and/or types of individual. For example, the device can be provided without cell phone capabilities, which may be preferable for children, for example of ages 5-12 years.

Other groups toward which devices can be specifically repackaged include adult females, elderly, impaired or infirm individuals, teenagers, sports enthusiasts, travelers and the like, to provide non-limiting examples.

In addition, the device can further be repackaged for hidden applications, for example by being incorporated into shoes, car seats, and other locations where the device is likely to be difficult to detect, for example by a hostile individual, kidnapper or the like.

In accordance with a further aspect of the invention, the device of the present invention can be incorporated into processors such as computers, especially PC's and the like, to enhance functionality of same, and can be adapted for use with PCMIA, Compaq Flash and other software packages for enhancing versatility. Features which can advantageously be incorporated into the present invention are further described as set forth below.

The device of the present invention can advantageously be pinged, such that the ping toggles the system so as to activate various features such as the direct connect or walkie-talkie feature, camera, and/or positioning features or the like. Such activation can also be triggered by pre-programmed events, such as the user, or device being carried by the user, leaving a certain area, or entering a certain area, or the like.

Through GPS and/or cell triangulation for zone coverage, messages such as text, auto or other types of alerts can be generated and transmitted to an authorized person when the device enters or leaves a defined zone.

The device can be adapted for emergency situations for example by being equipped with an emergency button, or emergency can be invoked via a code or device detected or external event trigger including triggered from a friend and family (if so enabled) and/or a monitoring center(s). If the cellular or direct connect, or VoIP signal or other network communication signals are not present the device can be adapted to flutter the GPS signal is such a manner that it can signal an emergency situation. The fluttering of GPS or other signal can be alerted to friends, family (if so enabled) and/or the monitoring center(s) as desired to allow for response to an emergency situation. The security of the correlated network identification coupled with the GPS signal or other triangulation is used to determine which subscriber is in an emergency situation. The device(s) can be equipped with an alarm feature. The alarm can be enabled by the user, triggered by an event (such as loss of blood pressure, heart rate change, etc.), the event can be detected by the device or by an event that is communicated by one of various networks that the device is communicating with, or the alarm can be invoked from a friend and/or family or other authorized individual and/or the monitoring center(s). The alarm can emit any of a wide range of suitable responses including but not limited to high decibel sounds, recorded voice announcements, live voice announcements or high frequency signals (can be out of human ear range) or any combination of these and other alert signaling methods.

The device can also be used for traffic and weather alerts. The traffic and weather alerts can use the GPS or cellular triangulation to determine and provide the closest traffic and weather data. Heuristics can be used from data sources such as weather, heart rates etc to automatically issue alerts and alarms to the subscriber, friends, family and co-workers (if desired and so enabled) and the monitoring center(s).

In the case where the devices are used for EMS workers the workers can use the device display to see location of co-workers, key vital signs and, if needed, create an alarm as well as see alarm types, locations, names and device sensor information. Under these circumstances, authorized individuals such as EMS commanders, for example, can send text, audio, video and graphical information to co-workers. The network servers can be configured to record and store the information and allow other agencies access to see and provide collaboration and alert information to better respond to emergency situations. Emergency information can be identified via heuristics or the event can be detected by the device or through events that are communicated via one of the various other networks that the device is communicating with, or the alarm can be invoked from a co-worker, commander, collaboration agency, friend, family and/or the monitoring center as desired and if so enabled.

The device is preferably mounted within a case which is water resistant and/or water proof, such that environmental conditions do not interfere with the critical function provided by same.

The device is advantageously programmable from one or more of different locations. Depending upon the device and intended user of same, it may be desirable to provide over the air programming for the device, and/or programming of the device utilizing soft keys on same. For example, programmable features may be desirably limited if the device is to be used by a child. In other circumstances, when the user is an adult, on-device programming may be desirable.

A monitoring feature is advantageously carried out, preferably by a dedicated system for receiving input from various devices in use by individuals. This monitoring station can advantageously record last known location, date and time of the device, a panic record and the like.

The device can further advantageously incorporate functionality including functions such as an MP3 player, or memory stick, or the like through a network, or such as a camera device, XM radio receiver or the like.

Further advantageous device features are as described in the appendix attached hereto, which further describes the device, system and methods of the invention and which is incorporated herein.

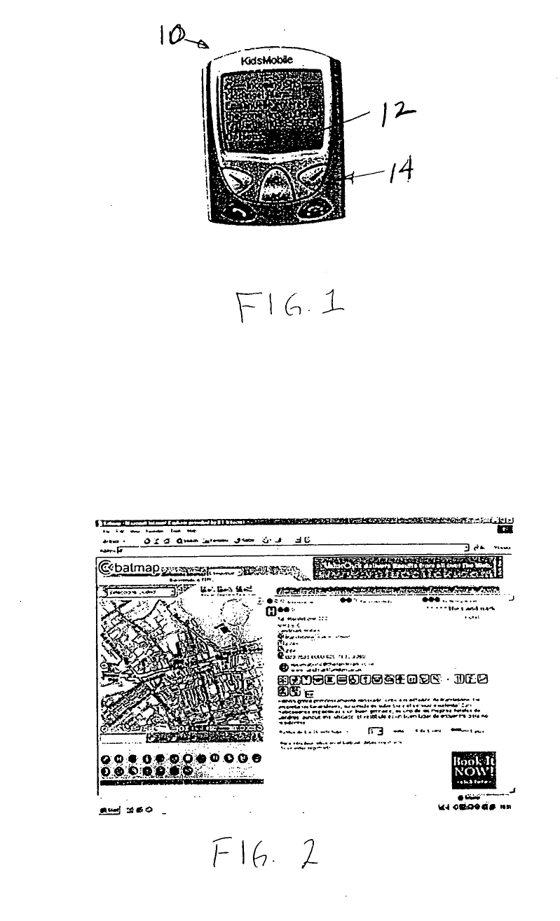

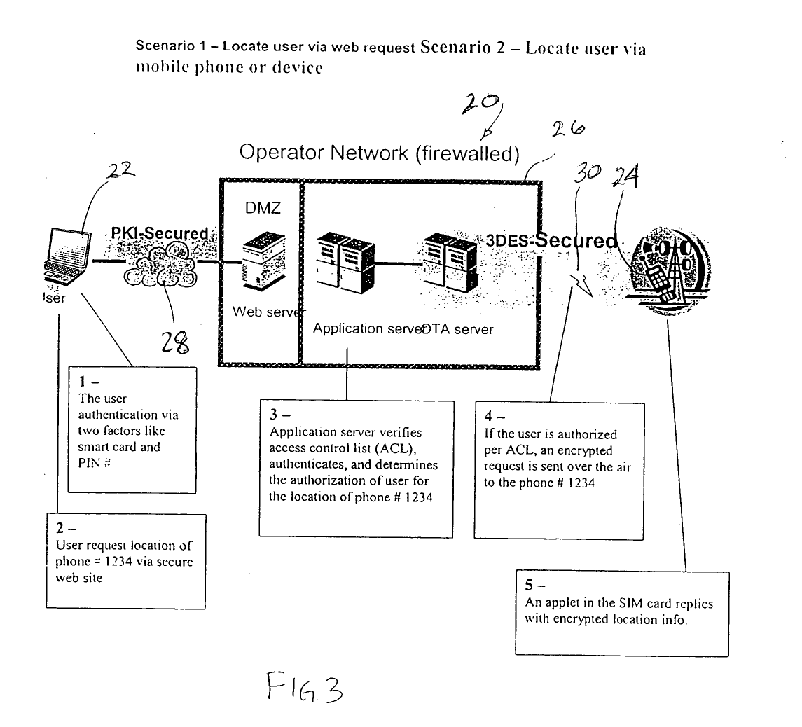

FIG. 2 illustrates a typical informational screen which could be accessed from a workstation by an authorized user to determine location of the monitored device as desired. Such a map display is particularly advantageous in that position of the monitored device, displayed on the map, can lead the authorized user or other law enforcement, emergency or other personnel quickly to a location of importance to provide assistance as necessary.

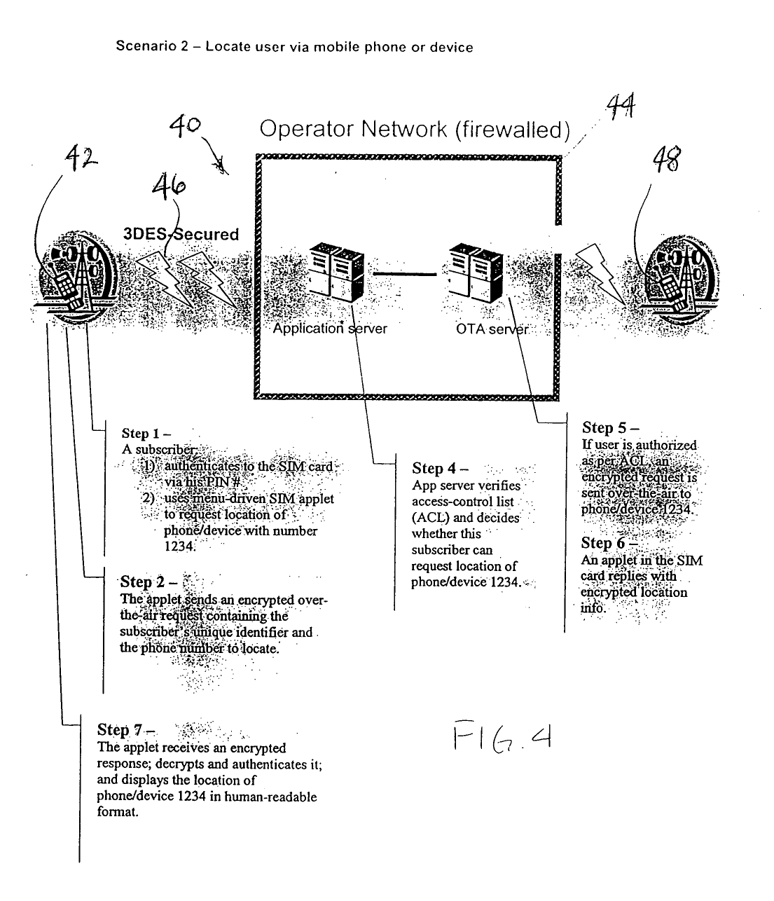

FIG. 3 schematically illustrates an operator network 20 in accordance with the present invention.

In FIG. 3, a user workstation 22 is illustrated which corresponds to an authenticated user who will use operator network 20 in accordance with the present invention to monitor location of a device 24 as desired. The workstation 22 is communicated with the support network 26, for example through PKI-secured communications 28, and support network 26 is advantageously communicated with device 24, for example through 3DES-secured communications 30.

User workstation 22 can advantageously be authenticated through two factors, for example through a smart card and pin number. Through workstation 22, the user can request location of device 24 through the secure connection to network 26.

At support network 26, the application server is advantageously adapted to verify that the person attempting to access the system is on an access control list, and the server further authenticates and determines the authorization of the user, for example the location of the phone making the inquiry. If the user is authorized, an encrypted request is sent from server network 26 to device 24, and an applet in the SIM card of device 24 replies with encrypted location information. In this manner, secure inquiry can be made from workstation 22 as to the location or other information related to device 24, through server network 26, as desired.

Turning to FIG. 4, a further operator network 40 is illustrated wherein a subscriber using a device 42 can access a server network 44 through 3DES-secured communication link 46. During such an inquiry, the subscriber using device 42 is given an opportunity to authenticate to a particular SIM card using a PIN. Using a menu-driven SIM applet, the location of a particular device, for example phone/device number 1234 (shown in the drawing as reference numeral 48) can be made. The applet within device 42 sends an encrypted over-the-air request to server 44 containing the subscriber's unique identifier and the phone number to locate.

The application server verifies the incoming call from the access-controlled list, and decides whether this subscriber has the authority to request location of phone/device 1234.

If the device 42 is authorized as per ACL, an encrypted request is sent over the air to phone/device 1234 (reference numeral 48), and an applet in the SIM card of device 48 replies with encrypted location information. This information is received by server 44 and forwarded through an encrypted response to the applet of device 42 which decrypts and authenticates the information. Such decrypted and authenticated information is then displayed at device 42, for example in the form of the location of phone/device 1234 (reference numeral 48) as desired.

It should of course be appreciated that the combination of functionality incorporated into a single device so as to provide direct connect voice communication along with GPS and cell triangulation location determination is advantageous and a novel combination of functionality.

Additional functionality to be incorporated into the device can include a set up for monitoring of hot zones or zones of comfort for the devices, coupled with alerts to be sent to authorize devices or users based upon movement from or into such zones.

Server based monitoring of the devices can be utilized at any time for the purpose of sending the address to the authenticated and authorized devices and users, and such information can be displayed on cell phones and the like.

Communication between the servers and the device can be voice authenticated, as can communication between the server and an authorized monitor device, and calls attempting to access information can advantageously be dropped if not authorized or authenticated.

Other authentication methods which can advantageously be used in accordance with the present invention include secret passwords, voice biometrics, fingerprint biometrics, one time passwords which can be rotated, smart cards and the like, and combinations thereof. Of course, other types of authentication can also be utilized.

The monitor-authorized user can advantageously configure the system to provide desired monitoring characteristics through web based application, if desired, or through other methods.

Medical databases can also advantageously be rendered accessible through the device by authorized users and devices, whereby medical attention can readily be provided to the carrier of the device if necessary.

The server aspect of the system of the present invention can advantageously include call centers for dispatching location, medical information and the like to law enforcement, medical and rescue personnel.

Particularly advantageous features of the present invention include the ping to toggle for activation aspect, which is particularly useful in connection with activation of the voice communication functionality and camera functionality of the device. This activation allows for passive monitoring of the condition of the individual carrying the device, which can be useful in a wide variety of circumstances.

It is also to be appreciated that the combination of GPS and cell triangulation incorporated into the device allows for full location coverage, indoors and outdoors, which is quite desirable for the device in accordance with the present invention.

Further, the device of the present invention can advantageously be adapted to use GPS location sensing, which is a high power drain function, only when needed while using cell triangulation when possible. In this way, battery life can be extended.

A preferred embodiment of the invention is drawn to use in enhancing the experience of an individual visiting a facility such as a theme park. In this regard, the theme park can provide a communication device, and/or the user can program that user's existing communication device, so as to enhance a theme park experience from time leading up to the visit, to arrival at the theme park, enjoyment of the facilities at the theme park, and following the visit.

A user having a device according to the invention which is communicated with a server related to the service provider or theme park operator can be used, for example, during the planning stages of a visit, through sending information related to the park, providing rates and new attraction information and the like.

The system of the invention can also be used to provide information on events at the park such as promotions for rides and parks, which could be targeted at age groups, and to provide travel options including cruises and the like.

A user having a device according to the invention can also use the system of the invention to conduct planning for a visit to the theme park, for example as follows.

Packing can be enhanced using the system of the invention, for example by providing reminders of things to bring, weather updates, a count down clock - time until theme park visit.

The system can further be adapted to provide travel related assistance such as remembering a parking spot (camera shot and or audio clip), to play games, take photos and provide an itinerary or link to a travel site. The system can also keep track of the distance yet to be traveled to arrive at the theme park.

Upon arrival, the system of the invention can provide alerts to front desk or other personnel that you are near by, which can allow the theme park operator to arrange a welcoming of the client/user and family members (at the hotel), to provide help with baggage, and for example to allow children to talk to their favorite Disney character.

The system of the invention can likewise be used to provide a parent child ID matcher. If the child wanders or is not with the parent when entering or leaving a Disney property, an alarm will sound indicating possible lost or abducted child.

The system can also be used to facilitate charge card use for on property transactions, obviously with parental limits set for children. The device can further act as a door key, and the user's room number can be posted to the device before arrival as well.

Additionally. the characters of the theme park can be communicated with used of the device, if desired, and can provide character-based wakeup calls and images.

As set forth above, the device of the present invention also enhances the actual visit to a theme park. For example, assuming that the device is provided with a camera feature, or access to a remote camera feature, the system of the invention can obtain a camera shot of the location of a parking spot, for example, and can provide this picture upon request.

The device of the present invention can also be used to access and display other features such as frequently asked questions, or FAQ, show times, park opening and closing times, and the like.

Further, tickets for rides can be advance booked, for example coupled with bypassing a user's reservation if that individual is not within the desired radius, for example x minutes before an event is to start.

The device cam provide for advance booking of rides, for example on the same day, and can further provide a zone alert (if the rider is not in close proximity to the attraction x minutes before the ride, or if the rider is to far then their reservation is automatically released).

The device of the present invention can also be used to provide automatic information based upon location, to make inquiry about specific rides, to determine the time left to advanced ride reservation, and to issue a reminder that the user is to be in a Zone for example to keep a reservation, and further to provide a schedule of reservations

The system can also be adapted to provide information as to activities or events which may be going on near the user (i.e. parades, show times, etc.), where to eat, where closest rest rooms/water fountains can be found and the like.

The system can be adapted to provide the best route through the theme park for handicapped or otherwise impaired individuals.

The system can further be adapted to identify those portions of the theme park visited on a particular day, as well as the percentage of the park which has not yet been visited. Such functionality can likewise advantageously identify attractions which have not been seen.

The system of the invention is further advantageously adapted to provide a recommended route through the park, which can be selected based upon different criteria such as the route to see the most attractions of interest, and the like.

The system of the invention can also be adapted to provide a translation of shows or features of the park, as appropriate, into other languages. Events such as fireworks and special events and the like can be listed as to viewing or show time and location views can be provided to assist individuals in deciding upon a location.

A search function can be adapted into the system as well, for example to allow a search for a favorite character, or one or more family members, or other facilities such as rest rooms, restaurants—by name or food group, lost and found, help station, stores, and the like.

Another aspect of the invention is drawn to use in making reservations, price checks, to view restaurant reviews, to view on line menus, for pre ordering, providing proximity alerts (seating wait and today's special), which charge card is suitable for on property use and the like, and to alert restaurants when you are close by so that the restaurant staff can have the table ready.

The system and device of the invention can also advantageously store the past route followed by a user, for example to determine the restaurant you last ate at, or to retrace steps to find a lost item, or the like.

It is anticipated that the theme park operators may provide suitable devices for use by theme park visitors and such devices may have rechargeable power sources which can advantageously be recharged at recharge stations throughout the park. Map updates can also be obtained or downloaded in such fashion.

The device can be provided having active cases, which enhance certain functions of the device such as game play, for example, and which can be interchangeable so that different cases can be selected for different games, etc. In this configuration, the device can track game points accumulated and facilitate redemption for prizes and the like.

The device can be adapted to communicate with plasma displays in the theme park for showing best routes, allowing game play on a large screen, allowing group game play and the like.

The device can also be adapted to function as a charge card for on property use, and can be used to pick up copies of photos and or video clips via the device as well.

The device can provide directions, for example how to return to a hotel, or what options there are to get to a location, and what is the best or fastest mode of transport.

The device of the invention can also be used to conduct check out including review of charges, approval of bill, call for pick up of bags, and to complete guest surveys.

Finally, the device can have function for the travel home and after arrival home as well, to continue to enhance the theme park experience and encourage repeat visits and/or spin off purchases or product use.

For example, the device can have a game function as set forth above, which is well suited for use during travel home. Further, the device can allow for taking and/or viewing of photos, an itinerary and the like, and can track the remaining distance or travel time to reach a home destination, and can continue to function in this manner for as long as the user desires.

It may be desirable for the theme park operator to encourage adaptation of user devices to provide the functions described herein, or to permanently provide such devices to the user, so that the device can be used to allow continued enjoyment of the products and services of the theme park operator after the visit is complete. For example, the device can be used to provide movie alerts, to identify new theme games which may be available only if you attend a particular movie, for example through reading of points at stores.

The device can further be adapted to provide reminders which can be coupled with photos, for example to remind a user such as to tell them “you were here last year—book now”. The device can also obtain and display new or updated attractions, send audio clip on new songs and the like.

The device can also be used to set up a show watch list, for example a schedule of favorite children's shows along with a local cable schedule for viewing of same, and can include a preview function.

The device can also function as a diary, for example to keep a diary of theme park highlights by tracking date and location highlights with photos and park map, and can even be adapted to obtain and record heart rate and blood pressure of the user on a particular ride.

The travel log is preferably automatically built. When the user takes a photo and or records an audio clip it is automatically placed into the date, time location sequence.

Another feature which can be incorporated into the system of the invention is to program a birthday card from a favorite character(s) which can include image and voice.

The device can be used for special events such as weddings including schedule, group call lists, pre-loaded device with entire parties and individual calling information, for example allowing alphabetized sorting, and the like. The device can have stored therein a set of bride and groom facts, as well as an on line concierge.

The device can also advantageously be used on tour groups, for example to provide a schedule, a group call list, a pre-load of the entire tour group parties with individual calling and alphabetized sorting, and the like.

The device can also be used advantageously for conferences or parties in similar manner.

The safety and security functions identified above are equally well suited to the theme park embodiment of the present invention, wherein the device can include an EMS Profile, locate missing people on and off property, provide the ability to know who was and was not in a location, protect this function with a password, access and store biometric information, provide a call center (for example including a pre fetch of data or valet service), to monitor medical signs (when monitors for heart, blood pressure, temperature, etc are used), to show closest and best routes for emergency exits, and to generate an alert if people should enter restricted areas.

The functionality of the device can be extended to cruise ships, stores that are off property, movies, games and even international locations.

The device of the present invention, in order to be used in the theme park embodiment described above, may be provided with the following additional functionality if desired:

voice communications (Direct Connect). Single button calling to any programmed member and or member can be dialed (typically entered via soft keys);

camera (still, sequence and short video) images are stored in the network and tagged with date, time, location, device and registered user ID. Images can be played back on the device, PC or Photos can be picked up at authorized stores;

GPS;

color display (soft keys) and touch screen (can support dual screen—simulcast image to device and network attached monitor);

IR port;

active case (character based, park based, theme, etc);

sensor option—for example for seniors and athletic (heart rate, blood pressure, etc);

SMS data delivery;

optional MP3 playback (expansion port for memory upgrades);

ear piece jack;

store and forward (network based—photos, audio clip, maps, etc.);

shock resistance and water proof;

multiple language support (in device and over the network);

a kid's UI (similar to game boy) and an adult UI (for example similar to Mac);

EMS profile—network based;

voice record network and device based;

games—self play, device to device or device to other network player; and

support IM.

It should be clear that the device as described above, particularly the device adapted for use in theme parks, can be used to greatly enhance the enjoyment and safety of the user of the device when visiting the park, and also can be used to enhance the theme park operator's ability to make known to the user what attractions, products, events and the like may be of interest.

It is to be understood that the invention is not limited to the illustrations described and shown herein, which are deemed to be merely illustrative of the best modes of carrying out the invention, and which are susceptible of modification of form, size, and arrangement of parts and details of operation. The invention rather is intended to encompass all such modifications which are within its spirit and scope.

1. A system for enhancing a theme park visit, comprising:
a communication device, and
a source of theme park related information,
wherein the communication device is communicated with the source whereby the information can be accessed and obtained by a user of the communication device.
